(19) United States
(12) Patent Application Publication
(10) Pub. No.: US 2004/0086842 A1
(43) Pub. Date: May 6, 2004

(54) Factors for enhancement of sperm survival

(76) Inventors: William Vincent Holt, Middlesex (GB); Alireza Fazeli, Sheffeild (GB); Paul Frederick Watson, Herts (GB); Roslyn Marie Ann Elliott, Essex (GB)

Correspondence Address: Jacobson Holman PLLC, 400 Seventh Street, N.W., Washington, DC, 20004, US

(21) Appl. No.: 10/619,907

(22) Filed: Jul. 11, 2003

Related U.S. Application Data
(63) Continuation-in-part of application No. 10/284,464, filed on Oct. 31, 2002, now abandoned.

(51) Int. Cl. A01N 1/00; A01N 1/02

(52) U.S. Cl. 435/1.1

(57) ABSTRACT

A method of improving and/or prolonging sperm viability which comprises contacting spermatozoa with an isolated, cell-free, protein obtainable from a peripheral membrane fraction of oviductal apical plasma membrane (APM), or a fragment or derivative therefrom, the protein having a molecular weight of between approximately 10 kDa and 100 kDa, which finds use in maintenance of sperm viability to increase the success rate of artificial insemination (AI).

### BACKGROUND OF THE INVENTION

This invention relates to maintenance of sperm viability to increase the success rate of artificial insemination (AI).

AI is now a fundamental technology for the intensive breeding of domestic animals, in human infertility treatments and in wildlife conservation programmes for the breeding of threatened species. Nevertheless, it has become clear that current semen preservation techniques severely compromise the sperm's survival in the female reproductive tract and hence limit the successful application of the technique.

Sperm survival is particularly compromised when spermatozoa cannot be delivered directly into the uterus because the cervical anatomy is too complex, for example in sheep. This significantly reduces the efficiency of AI. Large numbers of viable spermatozoa must be used to maximize the chance of fertilization, therefore making this technique uneconomical. Surgical intrauterine insemination by laparoscopy is an efficient way of solving this problem and through use of this method conception rates of 80% are now common in sheep and other species. However, this method increasingly is regarded as unacceptable for routine agricultural use on grounds of welfare; routine use of this surgical approach is expected to be curtailed within a relatively short period.

Means to improve the success rate of non-surgical methods is therefore urgently required. One means of achieving this will be by extending the lifespan of spermatozoa in the female reproductive tract.

Following mating (natural insemination), inseminated mammalian spermatozoa are transported to the oviduct where a reservoir of spermatozoa is formed. Studies in several species have shown that the reservoir is limited to the caudal isthmus. The spermatozoa are held in the isthmus until ovulation, when a small number are released to meet the egg(s). During storage in the isthmus, many spermatozoa attach to the oviductal epithelial cells. Attachment to oviductal epithelial cells is important in maintaining sperm viability both in vivo and in vitro. Spermatozoa attachment to oviductal epithelial cells is initiated by uncapacitated spermatozoa. The process of capacitation, along with the switch to the hyperactivated flagellar beating pattern, appears to coincide with the ability of spermatozoa to be released from the oviductal reservoir.

Coculture with whole oviductal epithelial cells in vitro improves the viability of sperm from a number of species including rabbit, cow, sheep, horse, pig and human. It seems this is a widespread characteristic of oviductal cells. However the mechanism by which oviductal cells maintain sperm viability is unknown.

Many studies in the past have only investigated the role of oviductal secretory products (proteins) on spermatozoa.

Oviductal secretory products have been reported to improve the viability of sperm. These secreted proteins are present in oviduct fluid and the fluids from which they are derived are collected via indwelling cannulae in the ampulla and isthmus of the oviduct. These secreted proteins are not derivable from whole oviductal cells in vitro, but must be collected by cannulation of the oviduct of cycling animals.

Catalase is an example of a secretory protein; this enzyme is known to protect spermatozoa against damage by reactive oxygen species.

In nearly all existing experimental models (epithelial monolayers or explants) spermatozoa were in contact with the oviductal cells and simultaneously exposed to oviductal secretions.

The inventors have shown previously that whole oviduct epithelial cells could be isolated and cultured, and that when co-incubated with spermatozoa at 39° C., the life of the spermatozoa could be extended for 2 to 3 days beyond the maximum lifespan of control spermatozoa incubated without cells. Sperm lifespan was judged by the use of tests for plasma membrane integrity.

The inventors have further shown that incubation of spermatozoa with porcine oviductal apical plasma membrane (APM) extends the life of the cultured spermatozoa.

The inventors have further shown that incubation of spermatozoa with boar oviductal apical plasma membrane (APM) extends the life of the cultured spermatozoa. The inventors have also identified that maintenance of sperm viability is not dependent on the oviductal region form where the membranes are obtained nor the stage of the reproductive cycle.

### SUMMARY OF THE INVENTION

According to the present invention there is provided a method of improving and/or prolonging sperm viability which comprises contacting spermatozoa with an isolated, cell-free, protein obtainable from a peripheral membrane fraction of oviductal APM, or a fragment or derivative therefrom, the protein having a molecular weight of between approximately 10 kDa and 100 kDa.

By “protein” is meant a protein associated with the apical plasma membrane, but which does not form an integral part of the phospholipid bilayer. An example of such a protein is a peripheral membrane protein; these are associated with membranes but do not penetrate the hydrophobic core of the membrane. They are often found in association with integral membrane proteins and can be removed from membranes by means that do not require the disruption of the membrane structure, for example salt washes. The proteins of the invention are generally soluble proteins.

By “fraction” is meant a part obtainable by precipitation and centrifugation of the APM of oviductal epithelial cells, which contains proteins associated with the apical membrane. This fraction does not include secretory proteins present in oviductal fluid.

By “isolated, cell-free” is meant the protein is substantially free from any intact cells and other proteins not originating from plasma membrane.

By “fragment or derivative” is meant a polypeptide or peptide fragment or a derivative of a polypeptide or peptide fragment which retains the sperm viability improving and/or prolonging activity.

By “improving sperm viability” is meant that the proportion of spermatozoa which are viable is greater in comparison with control spermatozoa.

By “prolonging sperm viability” is meant that the spermatozoa maintain their viability for a longer time period than the normal lifespan of control spermatozoa which is not contacted with the membrane fraction. This longer time period preferably extends for from one day to three days, or greater than three days.

Preferably the spermatozoa are contacted with the protein in vitro.

In another aspect of the present invention the spermatozoa are boar spermatozoa and the peripheral membrane fraction is of porcine oviductal APM.

According to the present invention there is provided a method of improving and/or prolonging sperm viability which comprises contacting spermatozoa with an isolated, cell-free protein obtainable from a peripheral membrane fraction of oviductal APM, or a fragment or derivative therefrom, the protein having a molecular weight of approximately 95 kDa.

According to the present invention there is provided a method of improving and/or prolonging sperm viability which comprises contacting spermatozoa with an isolated, cell-free protein obtainable from a peripheral membrane fraction of oviductal APM, or a fragment or derivative therefrom, the protein having a molecular weight of from approximately 60 to approximately 70 kDa.

According to the present invention there is provided a method of improving and/or prolonging sperm viability which comprises contacting spermatozoa with an isolated, cell-free protein obtainable from a peripheral membrane fraction of oviductal APM, or a fragment or derivative therefrom, the protein having a molecular weight of approximately 70 kDa.

According to the present invention there is provided a method of improving and/or prolonging sperm viability which comprises contacting spermatozoa with an isolated, cell-free protein obtainable from a peripheral membrane fraction of oviductal APM, or a fragment or derivative therefrom, the protein having a molecular weight of approximately 41 kDa.

According to the present invention there is provided a method of improving and/or prolonging sperm viability which comprises contacting spermatozoa with an isolated, cell-free protein obtainable from a peripheral membrane fraction of oviductal APM, or a fragment or derivative therefrom, the protein having a molecular weight of approximately 38 kDa.

According to the present invention there is provided a method of improving and/or prolonging sperm viability which comprises contacting spermatozoa with an isolated, cell-free protein obtainable from a peripheral membrane fraction of oviductal APM, or a fragment or derivative therefrom, the protein having a molecular weight of approximately 37 kDa.

According to the present invention there is provided a method of improving and/or prolonging sperm viability which comprises contacting spermatozoa with an isolated, cell-free protein obtainable from a peripheral membrane fraction of oviductal APM, or a fragment or derivative therefrom, the protein having a molecular weight of from approximately 19 to approximately 21 kDa.

According to the present invention there is provided a method of improving and/or prolonging sperm viability which comprises contacting spermatozoa with an isolated, cell-free protein obtainable from a peripheral membrane fraction of oviductal APM, or a fragment or derivative therefrom, the protein having a molecular weight of approximately 19 kDa.

According to the present invention there is provided a method of improving and/or prolonging sperm viability which comprises contacting spermatozoa with an isolated, cell-free protein obtainable from a peripheral membrane fraction of oviductal APM, or a fragment or derivative therefrom, the protein having a molecular weight of approximately 18 kDa.

According to the present invention there is provided a method of improving and/or prolonging sperm viability which comprises contacting spermatozoa with an isolated, cell-free protein obtainable from a peripheral membrane fraction of oviductal APM, or a fragment or derivative therefrom, the protein having a molecular weight of approximately 13.5 kDa.

According to the present invention there is provided a method of improving and/or prolonging sperm viability which comprises contacting spermatozoa with an isolated, cell-free protein obtainable from a peripheral membrane fraction of oviductal APM, or a fragment or derivative therefrom, in which the isolated protein comprises ribonucleotideprotein-2.

According to the present invention there is provided a method of improving and/or prolonging sperm viability which comprises contacting spermatozoa with ribonucleotideprotein-2 or a fragment or derivative therefrom.

According to the present invention there is provided a method of improving and/or prolonging sperm viability which comprises contacting spermatozoa with a protein other than ribonucleotideprotein-2 (acidic ribosomal protein P2), which protein includes all or part of the N-terminal sequence derived from acidic ribosomal protein P2 (eg includes all or part of the sequence MRYVASYLLA or an analog or homolog thereof).

According to the present invention there is provided a method of improving and/or prolonging sperm viability following cryopreservation which comprises contacting spermatozoa with an isolated, cell-free protein obtainable from a peripheral membrane protein fraction of oviductal APM, or a fragment or derivative therefrom, the protein having a molecular weight of between approximately 10 kDa and 100 kDa.

According to the present invention there is provided a method of improving and/or prolonging sperm viability during cryopreservation which comprises contacting spermatozoa with an isolated, cell-free protein obtainable from a peripheral membrane protein fraction of oviductal APM, or a fragment or derivative therefrom, the isolated protein having a molecular weight of between approximately 10 kDa and 100 kDa.

According to the present invention there is provided a method of isolating a protein having a molecular weight of between approximately 10 kDa and 100 kDa, or a fragment or derivative therefrom, having sperm viability improving and/or prolonging activity from oviductal APM comprising the steps of:

(i) harvesting mammalian oviduct epithelial cells;

(ii) separation and isolation of a plasma membrane preparation using a magnesium chloride solution, and centrifugation to obtain a crude APM fraction;

(iii) extraction of a soluble fraction from the crude APM fraction using a salt solution and centrifugation of the solution obtained;

(iv) concentration of the supernatant and washing, to obtain protein.

Preferably the salt solution used in step (iii) above is sodium chloride solution.

According to the present invention there is provided an isolated, cell-free protein having a molecular weight of between approximately 10 kDa and 100 kDa or a fragment or derivative therefrom, having sperm viability improving and/or prolonging activity, the protein, fragment or derivative obtainable according to the following method:

(i) harvesting mammalian oviduct epithelial cells;

(ii) separation and isolation of a plasma membrane preparation using a magnesium chloride solution, and centrifugation to obtain a crude APM fraction;

(iii) extraction of a soluble fraction from the crude APM fraction using a salt solution and centrifugation of the solution obtained;

(iv) concentration of the supernatant and washing, to obtain protein.

Preferably the salt solution used in step (iii) above is sodium chloride solution.

According to the present invention there is provided a method of improving and/or prolonging sperm viability which comprises contacting spermatozoa with an isolated, cell-free protein obtainable from a peripheral membrane fraction of oviductal APM, or a fragment or derivative therefrom, the protein having a molecular weight of between approximately 10 kDa and 100 kDa, in which the spermatozoa are microencapsulated.

By “microencapsulated”, is meant that the spermatozoa are enclosed within a semi-permeable membrane. Examples of membranes which can be used include beeswax, starch, gelatine, and polyacrylic acid and polylysine.

Preferably, the treated spermatozoa are microencapsulated in a semi-permeable membrane comprising poly-lysine.

According to the present invention there is provided a method of improving and/or prolonging sperm viability comprising contacting spermatozoa with an isolated, cell-free protein obtainable from a peripheral membrane fraction of oviductal APM, or a fragment or derivative therefrom, the protein having a molecular weight of between approximately 10 kDa and 100 kDa, in which the proteins are linked to inert polymers.

Preferably, hydrophilic polymers are used; these are defined as polymers having a solubility of greater than 10 g/L in an aqueous solution, at a temperature between 0 to 50° C. The aqueous solution can include small amounts of water-soluble organic solvents, such as dimethylsulfoxide, dimethylformamide, alcohols or acetone.

Examples of polymers which may be used in the present invention include synthetic polymers such as polyethylene glycol, polyvinyl alcohol, polyvinylpyrrolidone, hydroxylated celluloses, polypeptides, polysaccharides such as polysucrose or dextran and alginate. An example of a polymer which may be used in the present invention is amine and carbonyl-reactive dextran.

By “linked” it is meant that the polymers are joined to the proteins; the join may be through an ionic or covalent bond.

Linking proteins to inert polymers can result in the advantages of increased efficiency and reduced toxicity.

According to the present invention there is provided a method for improving and/or prolonging sperm viability which comprises contacting spermatozoa with an isolated, cell-free protein obtainable from a peripheral membrane fraction of oviductal APM, or a fragment or derivative therefrom, the protein having a molecular weight of between approximately 10 kDa and 100 kDa, in which the protein is present in a concentration of between approximately 0.1 μ/L and approximately 1 μ/L.

Preferably a concentration of between approximately 5 μg/L and approximately 400 μg/L is used. More preferably the concentration used is between approximately 25 μg/L and approximately 200 μg/L.

According to the present invention there is provided a method of improving and/or prolonging semen survival following sex-sorting of the spermatozoa for X- (female) and Y-bearing (male) spermatozoa cells which comprises contacting spermatozoa with an isolated protein obtainable from a peripheral membrane fraction of oviductal APM, or a fragment or derivative therefrom, the protein having a molecular weight of between approximately 10 kDa and 100 kDa.

According to the present invention there is provided a sperm diluent which includes an additive comprising an isolated, cell-free protein obtainable from a peripheral membrane fraction of oviductal APM, or a fragment or derivative therefrom, the protein having a molecular weight of between approximately 10 kDa and 100 kDa, in which the protein, fragment or derivative has sperm viability improving and/or prolonging activity.

Preferably, the sperm diluent or additive is synthetic. By synthetic we mean the diluent or additive is synthesised de novo. The advantage of synthetic diluents or additives is that these substantially eliminate the risk of transmitting viruses or other contaminants which might be associated with products obtained directly from mammalian tissue.

According to the present invention there is provided an isolated, cell-free protein obtainable from a peripheral membrane fraction of oviductal APM, the protein having a molecular weight of between approximately 10 kDa and 100 kDa, or a fragment or derivative therefrom, in which the protein, fragment or derivative has sperm viability improving and/or prolonging activity.

According to the present invention there is provided an isolated, cell-free protein obtainable from a peripheral membrane fraction of oviductal APM, or a fragment or derivative therefrom, the protein having a molecular weight of approximately 95 kDa, in which the protein, fragment or derivative has sperm viability improving and/or prolonging activity.

According to the present invention there is provided an isolated, cell-free protein obtainable from a peripheral membrane fraction of oviductal APM, or a fragment or derivative therefrom, the protein having a molecular weight of from approximately 60 to approximately 70 kDa, in which the protein, fragment or derivative has sperm viability improving and/or prolonging activity.

According to the present invention there is provided an isolated, cell-free protein obtainable from a peripheral membrane fraction of oviductal APM, or a fragment or derivative therefrom, the protein having a molecular weight of approximately 70 kDa, in which the protein, fragment or derivative has sperm viability improving and/or prolonging activity.

According to the present invention there is provided an isolated, cell-free protein obtainable from a peripheral membrane fraction of oviductal APM, or a fragment or derivative therefrom, the protein having a molecular weight of approximately 41 kDa, in which the protein, fragment or derivative has sperm viability improving and/or prolonging activity.

According to the present invention there is provided an isolated, cell-free protein obtainable from a peripheral membrane fraction of oviductal APM, or a fragment or derivative therefrom, the protein having a molecular weight of approximately 38 kDa, in which the protein, fragment or derivative has sperm viability improving and/or prolonging activity.

According to the present invention there is provided an isolated, cell-free protein obtainable from a peripheral membrane fraction of oviductal APM, or a fragment or derivative therefrom, the protein having a molecular weight of approximately 37 kDa, in which the protein, fragment or derivative has sperm viability improving and/or prolonging activity.

According to the present invention there is provided an isolated, cell-free protein obtainable from a peripheral membrane fraction of oviductal APM, or a fragment or derivative therefrom, the protein having a molecular weight of from approximately 19 to approximately 21 kDa, in which the protein, fragment or derivative has sperm viability improving and/or prolonging activity.

According to the present invention there is provided an isolated, cell-free protein obtainable from a peripheral membrane fraction of oviductal APM, or a fragment or derivative therefrom, the protein having a molecular weight of approximately 19 kDa, in which the protein, fragment or derivative has sperm viability improving and/or prolonging activity.

According to the present invention there is provided an isolated, cell-free protein obtainable from a peripheral membrane fraction of oviductal APM, or a fragment or derivative therefrom, the protein having a molecular weight of approximately 18 kDa, in which the protein, fragment or derivative has sperm viability improving and/or prolonging activity.

According to the present invention there is provided an isolated, cell-free protein obtainable from a peripheral membrane fraction of oviductal APM, or a fragment or derivative therefrom, the protein having a molecular weight of approximately 13.5 kDa, in which the protein, fragment or derivative has sperm viability improving and/or prolonging activity.

According to the present invention there is provided a use of an isolated, cell-free protein obtainable from a peripheral membrane fraction of oviductal APM, or a fragment or derivative therefrom, the protein having a molecular weight of between approximately 10 kDa and 100 kDa, in the manufacture of a composition for improving and/or prolonging sperm viability.

According to the present invention there is provided a use of ribonucleotideprotein-2 or a fragment or derivative therefrom, in the manufacture of a composition for improving and/or prolonging sperm viability.

According to the present invention there is provided a use of a protein which includes all or part of the N-terminal sequence derived from acidic ribosomal protein P2 (eg which includes all or part of the sequence MRYVASYLLA or an analog or homolog thereof), in the manufacture of a composition for improving and/or prolonging sperm viability.

According to the present invention there is provided a use of an isolated, cell-free protein obtainable from a peripheral membrane fraction of oviductal APM, or a fragment or derivative therefrom, the protein having a molecular weight of between approximately 10 kDa and 100 kDa, in the manufacture of a composition for improving and/or prolonging sperm viability following cryopreservation.

According to the present invention there is provided a use of an isolated, cell-free protein obtainable from a peripheral membrane fraction of oviductal APM, or a fragment or derivative therefrom, the protein having a molecular weight of between approximately 10 kDa and 100 kDa, in the manufacture of a composition for improving and/or prolonging sperm viability during cryopreservation.

According to the present invention there is provided spermatozoa together with an isolated, cell-free protein obtainable from a peripheral membrane fraction of oviductal APM, or a fragment or derivative therefrom, the protein having a molecular weight of between approximately 10 kDa and 100 kDa and having sperm viability improving and/or prolonging activity, which are microencapsulated with a semi-permeable membrane.

According to the present invention there is provided spermatozoa together with an isolated, cell-free protein obtainable from a peripheral membrane fraction of oviductal APM, or a fragment or derivative therefrom, the protein comprising ribonucleotideprotein-2 and having sperm viability improving and/or prolonging activity, which are microencapsulated with a semi-permeable membrane.

According to the present invention there is provided a method for identifying an isolated, cell-free protein obtainable from a peripheral membrane fraction of oviductal APM, or a fragment or derivative therefrom, the protein having a molecular weight of between approximately 10 kDa and 100 kDa and having sperm viability improving and/or prolonging activity the method comprising:

(i) labelling peripheral APM proteins with a marker

(ii) allowing the labelled APM proteins to bind to surface proteins of spermatozoa

(iii) washing to remove excess APM

(iv) adding a detergent to solubilise sperm surface proteins

(v) identifying the isolated proteins labelled with the marker which have bound to the surface proteins of the spermatozoa.

According to the present invention there is provided an isolated, cell-free protein obtainable from a peripheral membrane protein fraction of oviductal APM, or a fragment or derivative therefrom, the protein having a molecular weight of between approximately 10 kDa and 100 kDa and having sperm viability improving and/or prolonging activity, the protein obtained according to the following method:

(i) labelling peripheral APM proteins with a marker

(ii) allowing the labelled APM proteins to bind to surface proteins of spermatozoa

(iii) washing to remove excess APM

(iv) adding a detergent to solubilise the sperm surface proteins

(v) identifying the APM proteins labelled with the marker which have bound to the surface proteins of the spermatozoa

(vi) separating the labelled APM proteins from the surface proteins of the spermatozoa to obtain isolated protein.

### BRIEF DESCRIPTION OF THE DRAWINGS

The invention will next be described in more detail by way of example with reference to the accompanying drawings in which:

FIG. 1 shows the visible protein profile of initial homogenates of lung (A), follicular phase isthmic (B) and follicular phase ampullar (C) tissues and their corresponding APM preparations (D, E and F respectively);

FIG. 2 shows the visible protein profile of oviductal APM preparations (A), peripheral membrane proteins (B) and pellet left after the recovery of peripheral membrane proteins (C);

FIG. 3 shows the visible protein profile of APM proteins (tracks marked 3 and 4) where track 4 has been treated with the protease V8 from Staphyloccocus aureus;

FIG. 4 shows a comparison of the visible protein profiles of solubilised APM shown in FIG. 3;

FIG. 5 shows a protein sequencing report for the protein shown in FIG. 3, seen at 0.8 and 0.9 Rf distance down track; and

FIG. 6 shows a visible protein profile of Neutravidin/HRP binding to biotinylated APM proteins.

FIG. 7 shows Biotinylated soluble apical plasma membrane (sAPM) proteins of approx. 18, 19, 37 and 70 kDa and at higher molecular weights binding to spermatozoa (lanes 1 and 2). There is specific labelling to the biotinylated unbound sAPM (lanes 3 and 4) and to the biotinylated standards (lane 7). There is no labelling to non-biotin treated sAPM or spermatozoa proteins (lanes 5 and 6). FIG. 8 a) Glycoprotein staining of glycosylated sAPM proteins at approximately 31 and 38 kDa can be seen on the gel (lane 2) together with stained glycosylated standards at 180, 82, 42 and 18 kDa (lane 1).

FIG. 8 b) shows Coomassie Blue stained sAPM proteins and glycosylated and non-glycosylated standards (lanes 3, 4 and 5 respectively).

### DETAILED DESCRIPTION OF THE PREFERRED EMBODIMENTS

Oviduct and Lung Tissue Preparation

Porcine lung and oviduct tissues were obtained and oviducts (attached to ovaries) were cleaned and washed with cold PBS. The oviducts were divided into two groups designated: FOL (follicular) and LUT (luteal), based on the appearance of the associated ovaries. Those oviducts attached to ovaries containing large follicles (8-12 mm in diameter) with signs of recent ovulation and no corpora lutea were assigned to the FOL group, those with ovaries containing several corpora lutea, without large follicles were assigned to the LUT group. Oviducts in both groups were trimmed from the ovaries and washed by passing four times through PBS. Each oviduct was divided into three sections; the first, designated as ampulla, was a section between the fimbria and the middle (thicker part) of the oviductal tube. The second section designated as isthmus, consisted of 1-2 cm of the caudal part of the uterine horn, the uterotubal junction, and up to nearly the middle (thinner part) of the oviductal tube. Finally, a section around the junction of the thin and thick part of the oviductal tube, approximately 2-3 cm long, was excised and discarded to assure differentiation of isthmic and ampullar parts of the oviduct. Each oviduct section (isthmic or ampullar) was processed separately. They were opened longitudinally and epithelia were scraped into a petri dish using a clean glass microscope slide. Scraped tissues collected from approximately 8-12 oviduct sections were collected separately (FOL isthmus, FOL ampulla, LUT isthmus and LUT ampulla) into 20 ml of cold PBS and kept on ice. These suspensions were centrifuged for five minutes at 200 g. The supernatants were discarded and pellets were resuspended in 20 ml of buffer 1 containing 60 mM mannitol, 5 mM EGTA, 1 μM phenylmethylsulfonylfluoride (PMSF), Tris base (pH 7.4). Suspensions (5 ml) were snap frozen in liquid nitrogen and stored at −80° C. until subsequent use for APM preparation.

Porcine lung tissues were chopped finely to a volume of 5 ml to which 20 ml of Buffer 1 was added. The lung tissue homogenates were snap frozen in liquid nitrogen and stored at −80° C. until subsequent use for APM preparation.

Porcine duodenal tissues (8-12 cm) were opened longitudinally and epithelia were scraped into a petri dish using a clean glass microscope slide. Scraped tissues were collected into 20 ml of cold PBS and kept on ice. These suspensions were centrifuged for five minutes at 200 g. The supernatants were discarded and pellets were resuspended in 20 ml of buffer 1 (pH 7.4). Suspensions (5 ml) were snap frozen in liquid nitrogen and stored at −80° C. until subsequent use for APM preparation.

APM Preparation

Tissue homogenates were thawed and homogenized on ice for one minute using a small homogeniser (Silverson, Waterside, UK). Two hundred microliter aliquots of this initial homogenate were snapfrozen in liquid nitrogen and stored at −80° C for subsequent analysis. The homogenate was supplemented with 200 μl of 1 M MgCl₂ followed by 30 minutes incubation on ice. Thereafter the homogenate was centrifuged for 15 minutes at 3000 g. The pellet was discarded and the supernatant was centrifuged for 30 minutes at 90,000 g. After centrifugation, the pellet was resuspended in 20 ml of buffer 2 containing 60 mM mannitol, 7 mM EGTA, Tris base (pH 7.4) with ten strokes of a Potter S homogenizer. The homogenate was supplemented with 200 μl 1 M MgCl₂ and incubated on ice for 30 minutes. Afterwards, the mixture was centrifuged at 3000 g for 15 minutes. The pellet was discarded and the supernatant was centrifuged at 90,000 g for 30 minutes. The pellet, following ultracentrifugation, was resuspended in 20 ml of a modified Tyrode's medium containing 2 mM CaCl₂, 3.1 mM KCl, 0.4 mM MgCl₂6H₂O, 100 mM NaCl, 25 mM NaHCO₃, 0.3 mM NaH₂PO₄2H₂O, 10 mM HEPES, 21.6 mM Sodium lactate and 1 mM sodium pyruvate with ten strokes of a Potter S homogenizer. The suspension was centrifuged for 30 minutes at 90,000 g. The supernatant was discarded and the pellet was resuspended in 900 μl of the modified Tyrode's medium by aspiration through a 0.9×90 mm Yale spinal needle (Becton Dickinson, Oxford, UK). This fraction was portioned, snap-frozen in liquid nitrogen and stored at −80° C.

Isolation of peripheral membrane proteins from oviductal APM Preparations

An aliquot of oviductal APM preparation obtained from a mixture of FOL, LUT, isthmic and ampullar oviductal tissues was added to an equal volume of 2 M NaCl solution containing 2 μM PMSF. The mixture was incubated at 40° C. for 30 minutes. Thereafter it was centrifuged for 1 hour at 100,000 g at 10° C. The pellet was washed twice with a modified Tyrode's medium and stored at −80° C. The supernatant containing peripheral membrane proteins was carefully separated and then concentrated using microcon centrifugal filter devices (Millipore UK Ltd, Watford, UK). The concentrated peripheral membrane protein fraction was washed twice with a modified Tyrode's medium and stored at −80° C.

Protein and y-glutamyl transpeptidase Activity Analysis

Protein concentrations of initial homogenates, final APM preparations from different tissues, and peripheral membrane protein fractions obtained from oviductal APM, were measured (Bio-Rad Protein Assay kit, Bio-Rad, Hemel Hempstead, UK). The kit is based on a dye-binding assay, in which the colour of the dye changes differentially, in response to change in protein concentration.

γ-glutamyl transpeptidase has previously been shown to reside mainly in the APM of polarized epithelial cells. The activity of γ-glutamyl transpeptidase in the initial homogenate and in the APM preparations was measured calorimetrically, using the Sigma diagnostic kit 545 (Sigma, Poole, Dorset, UK). The assay is based on the transfer of the glutamyl group from L-glutamyl-pnitroanilide to glycylglycine catalyzed by γ-glutamyl transpeptidase. The liberated p-nitroaniline is diazotized by the addition of Sodium Nitrite and Ammonium Sulfamate. The absorbance of the pink azo-dye resulting from the addition of N(1-napthyl)-ethyl-enediamine, measured at 530-550 nm, is proportional to γ-glutamyl transpeptidase activity. The degree of enzyme enrichment was expressed as fold increase in γ-glutamyl transpeptidase activity in the final APM preparations compared to the initial homogenate. This demonstrated the success of the method employed to isolate APM preparations from the initial homogenates. In addition, distinct differences in the protein profile of APM preparations were observed compared to that of original homogenates. Three proteins diminished and three were enriched in APM preparations compared to that of the initial oviductal homogenates.

Gel Electrophoresis

Protein separation was performed using the discontinuous buffer system. Five μg protein of original homogenate and purified APM preparations obtained from FOL isthmic, FOL ampullar, LUT isthmic, LUT ampullar and lung tissues were loaded on SDSpolyacrylamide gels (12% separation, 5% stacking). Gels were electrophoresed for 1 hr at 180 volts. Gel electrophoresis procedures were carried out using a Bio-Rad Modular Mini Electrophoresis System (Bio-Rad Labs, Hemel Hempstead, Herts, UK). Following electrophoresis the gels were fixed and then stained with Brilliant Blue G-Colloidal concentrate (Sigma). A digital image was produced from stained gels using a Hewlett Packard Scanjet 6200c scanner (Calif., USA). The image was further analyzed using Scion image Beta 4.0.2 software program( Scion Corporation, Maryland, USA). Protein profiles of oviduct peripheral membrane proteins, pellet left after the recovery of peripheral membrane proteins and oviductal APM were produced and analyzed using the methodology described above.

Semen Preparation

Boar semen, diluted and stored for 24 hrs in Beltsville thawing solution was obtained and the semen (45 ml) washed three times with PBS by centrifugation and resuspension (600 g for 10 min). After the last centrifugation the supernatant was discarded, and the pellet was resuspended in the modified Tyrode's medium supplemented with 12 mg/ml BSA, 200 U/ml penicillin, 200μg/ml streptomycin and 0.5 μg/ml amphotericin B (Life Technologies, Paisley, UK) (supplemented Tyrode's medium). One ml of washed semen sample was overlaid with 500 μl of supplemented Tyrode's medium in a test tube. The tube was placed at a 45° angle in an incubator held at 39° C. in a humidified atmosphere saturated with 5% CO2. After one hour the top 0.5 ml of medium containing the swim-up spermatozoa fraction was collected. Spermatozoa concentration was measured using a counting chamber. Sperm viability was assessed using a combination of Ethidium homodimerl(ETHD-1; Molecular Probes, Leiden, The Netherlands) and SYBR-14 (Molecular Probes). One μl of 2 mM ETHD-1 and 2.5 μof 20 μM SYBR-14 were diluted in 1 ml of PBS. An equal volume of the dye mixture was added to the semen sample and incubated for 20 minutes at 39° C. An aliquot of this preparation was placed on a slide and evaluated by epifluorescence microscopy (×40 objective). Viable spermatozoa with intact membrane excluding ETHD-1 demonstrated green fluorescence over the nucleus due to SYBR-14 staining. Spermatozoa with disrupted membranes showed red nuclear fluorescence due to ETHD-1 staining. Two hundred spermatozoa were evaluated by fluorescence microscopy and classified as membrane intact (green) or membrane damaged (red).

Sperm-APM Coincubation

Swim-up spermatozoa fractions (50×106 spermatozoa/ml) in 25 μl aliquots were added to 25 μl of APM (variable concentrations depending on experimental design). Sperm-APM coincubation droplets were covered with mineral oil, incubated at 39° C., 5% CO2 for 24 hrs. After coincubation 50 μl of PBS containing 20 μM SYBR-14 and 2 μM ETHD-1 was added to each droplet and further incubated for 15 min. Thereafter the sperm viability was assessed as described above.

Preparation of APM Proteins that Bind to Sperm, for Sequencing.

APM proteins (soluble fraction) were labelled with biotin. Biotinylation of pAPM proteins was performed using Sulfo-NHS-LC-Biotin (Product no. 21335 Pierce, Rockford, Ill.). Based on previous SDS-PAGE protein profiles of pAPM an assessment of approximately 75 kDa, as the average protein molecular weight, was used to calculate the final working volume of biotin (3 microlitres) and this was incubated with the pAPM for 30 minutes at room temperature. After incubation excess biotin was removed by a series of concentrating and washing steps using 3,000 dalton cut-off microfuge concentrators and mini-dialyzers. The initial mixture was microfuged for 75 minutes at 13,000 rpm. The retentate was collected by reverse spinning for 4 minutes at 3,000 rpm. The retentate was re-suspended in PBS up to 100 ml and transfered to 3,000 dalton cut-off mini dialyzers. These were gently rotated in 400 ml PBS for 1 hour, repeated once more before leaving overnight in fresh PBS to remove excess biotin. The samples were transferred to 3,000 dalton cut-off microfuge concentrators and spun for 90 minutes at 13,000 rpm. The retentate was collected by reverse spinning for 4 minutes at 3,000 rpm and re-suspended in modified Tyrode's solution (as above) to approximately the original pAPM starting volume. The protein concentration of the samples was measured before freezing the samples −20° C.

These labelled proteins were allowed to interact for 1 hour at 39° C. with an active population of boar sperm that had been selected by a “swim-up” technique. Sperm concentration was adjusted to 50×106 with TALP and pAPM protein concentration adjusted to 300 mg/ml with TLP. The biotinylated pAPM was added to an equal volume of spermatozoa and the suspension divided into two Eppendorf tubes. With the tubes remaining open the suspensions were incubated at 39° C. 5% CO2 for one hour. After this time the sperm suspensions were microfuged at 5,000 rpm for 4 minutes to begin removal of unbound PAPM. The supernatants were removed and the pellet resuspended in 500 ml of PBS. The suspensions were spun at 5,000 rpm for 4 minutes and the supernatants discarded. The pellets were resuspended in PBS and washed again to wash away excess APM. The pellets were resuspended in 10 ml of SDS sample buffer (50 mMTris@ 6.8 pH and 0.5% SDS) to solubilise sperm surface proteins and aggregated. A further 20 ml of sample buffer was added to the suspension, which was incubated at room temperature for 90 minutes. The mixture was spun at 13,000 rpm for 10 minutes. The soluble fraction comprising sperm surface proteins and bound pAPM proteins was carefully aspirated with a pasteur pipette and stored at −80° C. The pellet (sperm solids) was resuspended in 40 ml of sample buffer and saved. All samples were assayed for protein concentration.

These proteins (sperm+bound APM) were separated using SDSPAGE. The gels were probed with neutravidin and chemiluminescence to see whether any biotin-labelled bands were present. Briefly, biotinylated proteins transferred to the nitrocellulose embranes were detected by NeutrAvidin/HRP using the SuperSignal West Dura Western Blotting Kit Product No. 37081 (Pierce, Rockford Ill.) following the instructions supplied. To visualise the biotinylated proteins the membranes were exposed to X-ray type film for less than a minute.

Sequencing of the bands was carried out by contractors.

Microencapsulation of Sperm

Suspensions of sperm in physiological saline containing 1% sodium alginate (w/v), pH 6.8, were passed through a syringe pump to form droplets having a mean diameter of between 0.75 and 1.5 mm. Briefly, the sperm suspension within a 10 ml syringe was forced through a 19 gauge hypodermic needle contained within an encapsulating jet at a rate of approximately 1.5 ml/min to form droplets which were collected in a beaker containing aqueous solution (80 ml) of 1.5% CaCl₂-Hepes buffer (50 mM) pH 6.8. Immediately on contact with the CaCl₂-Hepes buffer solution, the droplets absorb calcium ions, which causes solidification of the entire-cell suspension resulting in a shape-retaining, high viscosity microcapsule. To form a semi-permeable membrane on the surface of the microcapsules, the microcapsules were rinsed three times with physiological saline and suspended in physiological saline containing 0.4% polylysine having a molecular weight range of 25 to 50 kDa, the excess polylysine was aspirated and the microcapsules rinsed with 0.1% CHES buffer, pH 8.2. After three rinses with physiological saline, the alginate gel inside the microcapsules was liquefied by suspending the capsules in isotonic 3% sodium-citrate saline solution, pH 7.4 for approximately 5 minutes.

Cryopreservation of Sperm.

Collected semen was allowed to cool slowly to room temperature over a period of around 2 hours. Semen was aliquoted into tubes containing approximately 6×10⁹ spermatozoa and centrifuged at room temperature for 10 minutes at 300 g. The supernatant was removed by aspiration and the spermatozoa resuspended into Beltsville F5 extender (5 ml).

The tubes containing the extended spermatozoa were then placed in a beaker containing water (50 ml) at room temperature, which was then placed into a refrigerator and cooled to 5° C. over a two hour period. After the spermatozoa were cooled, 5 ml of Beltsville F5 extender containing 2% glycerol was added to each tube. The contents of the tubes were mixed by immersion and frozen immediately into pellets of 0.15 ml to 0.2 ml on dry ice. The pellets were then transferred to liquid nitrogen for storage.

When required for insemination, 10 ml of pellets were removed from the liquid nitrogen and held at room temperature for 3 minutes before being placed in a 250 ml beaker containing 25 ml Beltsville thawing solution which had been pre-warmed to 50° C. to thaw the semen.

Preparation of Fertilized Oocytes for IVF Treatment

Ovaries were collected and placed in 0.9 wt % saline containing at 25 to 30° C. Oocytes were aspirated from follicles using a 20 gauge needle connected to a 10 ml disposable syringe, transferred to a 50 ml conical tube and allowed to sediment at room temperature. Supernatant was discarded and follicular contents washed with Tyrode's Lactate (TL)-Hepes medium supplemented with 0.01% PVA (TL-Hepes-PVA). Oocytes with an evenly granulated cytoplasm and surrounded by compact cumulous cells were washed twice with TL-Hepes-PVA and three times in IVM medium. Oocytes were suspended in 500 μl of IVM medium in a four well multidish and cultured for 42 to 44 hours.

On completion of IVM, cumulus cells were removed by treatment with 0.1% (w/v) hyaluronidase in basic IVM medium and vortexed for 1 minute. Denuded oocytes were washed three times in 500 μl of IVM medium and then washed three times in IVF medium containing 1 mM caffeine and 1 mg/ml BSA. Oocytes were placed into 50 μl drops of pre-equilibrated IVF medium and covered with warm paraffin oil in a 35×10 mm² polystyrene culture dish. A frozen semen pellet was thawed and washed three times by centrifugation (1900×g for 4 minutes) in Dulbecco's PBS supplemented with 1 mg/ml BSA, 75 μg/ml potassium penicillin G and 50 μg/ml streptomycin sulfate (pH 7.2) The sperm pellet was then resuspended in IVF medium containing 1 mM caffeine and 0.1% (w/v) BSA and 50 μl of the sperm suspension was added to 50 μl drops of IVF medium containing the oocytes. The final sperm concentration was 2.5 to 3.5×10⁵/ml. Spermatozoa and oocytes were incubated for 6 hours at 39° C., 5% CO₂ (w/v) in air.

Statistical Analysis

The data were expressed as mean viability index±SEM. Viability index was defined as percentage of viable spermatozoa after 24 hours incubation in comparison to that of the initial viability of the same semen sample at the beginning of incubation period. Sperm viability data were tested for normal distribution. Analysis of variance was used for the statistical analysis of the data. The level of significance was considered P=0.05.

The invention will now be further illustrated by means of the following examples.

### EXAMPLE 1

### Determination of the Visible Protein Profile of Initial Homogenates and APM Preparations

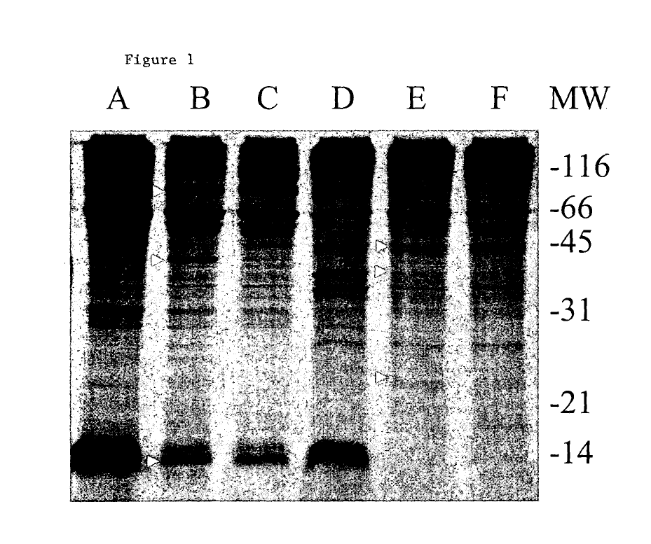

The visible protein profile of initial homogenates and APM preparations of isthmic, ampullar and lung tissues is presented in FIG. 1. The protein profiles of isthmic and ampullar preparations before purification were similar. Protein profiles of isthmic and ampullar APM preparations were also similar. Compared to the original homogenate, a subset of proteins (lane B; 45, 37 and 26 kDa) was enriched and another subset (Lane E; 77, 41 and 13 kDa) was diminished after purification of isthmic and ampullar APM preparations. There were distinctive differences in protein profiles of lung and oviductal tissues before and after purification.

### EXAMPLE 2

### Determination of the Visible Protein Profile of APM Preparations and Peripheral Membrane Proteins

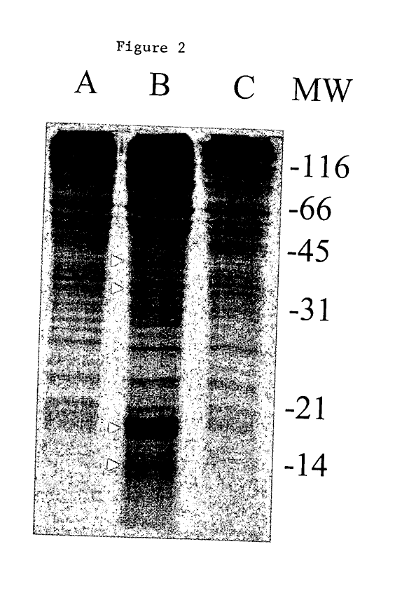

Protein profiles of oviductal APM preparations, peripheral membrane proteins and pellet left after the recovery of peripheral membrane proteins are presented in FIG. 2. The protein profile of oviductal APM was similar to that of the pellet left after the recovery of peripheral membrane proteins. The protein profile of peripheral membrane proteins showed enrichment for most of proteins visible in the profile, particularly for proteins of 41, 38, 18 and 13.5 kDa molecular weight (Arrows, lane B).

### EXAMPLE 3

### The Role of Protein Integrity in the Biological Activity of APM

The APM preparation extracted and isolated using the method described in the specific description was treated with Staphylococcus Aureaus V8. This treatment was shown to remove the viability enhancement properties. SDS-PAGE separation (soluble) before and after treatment with the protease showed few differences in the protein profile; however, protein bands of 19-21 KDa were found to have disappeared coincident with the disappearance of bioactivity.

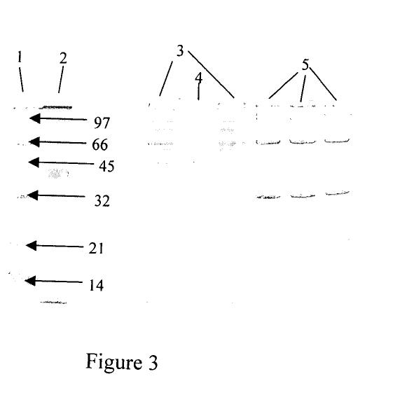

FIG. 3 shows a visible protein profile of APM proteins in tracks marked 3 and 4 of the SDS-PAGE. Track 4 has been treated with the protease V8 from Staphyloccocus aureus. Tracks 1 and 5 show standard marker proteins, higher molecular weights at the top.

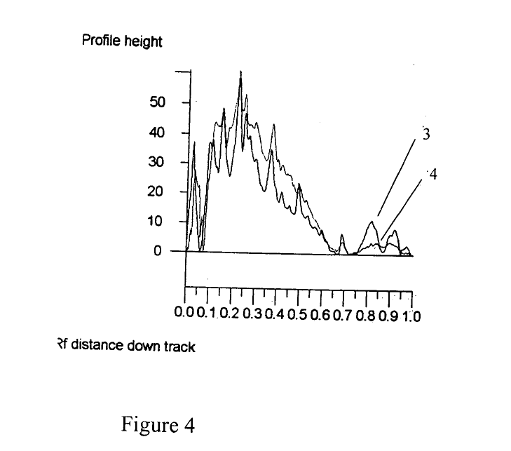

FIG. 4 compares the protein profile of solubilised APM which has been treated with protease (track marked 4), with the protein profiles of untreated solubilised APM (track marked 3). Proteins of approximately 18 and 19 kDa are seen at 0.8 and 0.9 Rf distance down the track for the untreated protein; these peaks are not present for the treated protein and thus it is clearly shown that the protease affects the proteins having molecular weights of approx. 18 and 19 kDa. The same effect is also seen for the protein having a molecular weight of 37 kDa.

### EXAMPLE 4

### Identification of Candidate Proteins Responsible for Bioactivity

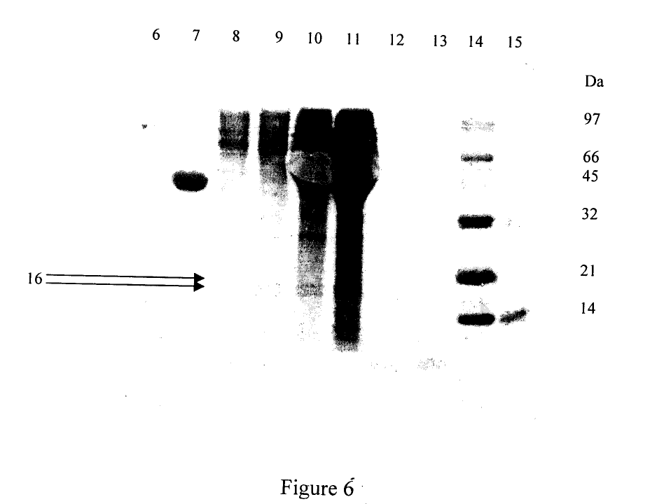

APM proteins (soluble fraction) were labelled with biotin using a procedure developed specifically for the purpose. These labelled proteins were allowed to interact for 1 hour at 39° C. with an active population of boar sperm that had been selected by a “swim-up” technique. Excess APM was then washed away and a detergent (Sodium Dodecyl Sulphate) added to solubilise sperm surface proteins. These proteins (sperm+bound APM) were separated using SDS-PAGE. The gels were probed with neutravidin and chemiluminescence to see whether any biotin-labelled bands were present. Two proteins, one at 18 kDa and the other at 19 kDA daltons, were found to have been biotinylated and had bound to sperm (see FIG. 6). These proteins were identified as those which had disappeared after protease treatment in the method described above. Tracks 1 and 15 show standard marker proteins; track 14 is biotinylated standards; Track 7 shows Kaleidoscope standard; Tracks 8 and 9 show sperm bound APM proteins; Tracks 10 and 11 show non-bound APM proteins; Track 12 shows nonbiotinylated standard proteins; and Track 13 shows swim-up sperm.

### EXAMPLE 5

### Identification of Proteins Bound to the Surface of Sperm.

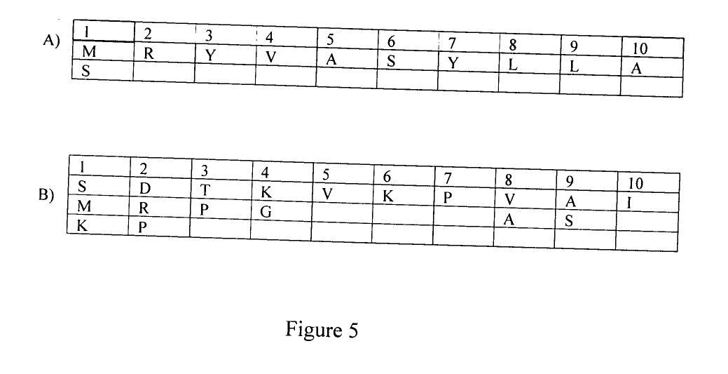

The N-terminus of a protein obtained in Example 5 was sequenced and identified as Ribonucleotideprotein-2; see FIG. 5 (A).

### EXAMPLE 6

### Microencapsulation of Sperm

A gel containing the spermatozoa is formed in an alginate matrix by means of exposure to calcium (divalent ion) and then forming a hydrogel layer of polymer shell, from materials such as poly-1-lysine, polyvinylamine, polyarginine or protamine sulphate.

The content is then changed to a sol by removing the divalent ions with ethylenediaminetetraacetic acid (EDTA)

### EXAMPLE 7

### Soluble Protein Fractions Obtained from Porcine Oviductal APM are Capable of Binding to Boar Spermatozoa In Vitro.

Materials and Methods

Apical Plasma Membrane Preparation

Fresh oviducts obtained from sows were separated from reproductive tissue donated by Dawkins Abattoir (Loughborough, UK) and transported to the laboratory in ice cold PBS. The oviducts were washed four times in PBS and kept on ice. They were opened longitudinally to expose the lumen. The oviductal epithelia were scraped with clean glass slides into PBS at 1 ml per oviduct. Aliquots of 20 ml were centrifuged for five minutes at 200 g. The supernatants were discarded and the pellets resuspended in 20 ml of Buffer 1 (60 mmol mannitol 1-1, 5 mmol 1-1 EGTA, 1 μmol Phenylmethylsulfonylfluoride (PMSF) 1-1 in Tris base pH 7.4). The oviductal epithelial cell (OEC) suspensions were snap-frozen and stored at −80° C. until required for apical plasma membrane (APM) preparation.

The APM fractions were isolated from the OEC by a method described by Smith and Nothnick (1997) with minor changes and solubilized using a similar method to that described by (Ohlendieck, 1996). Briefly, the OEC suspensions were thawed and homogenized on ice for one minute using a small homogenizer (Silverson, Waterside, UK). The homogenate was supplemented with 200 μl of 1 mol MgCl2 1-1 (10 mmol 1-1 final concentration) followed by 30 minutes incubation on ice prior to centrifugation for 15 minutes at 3000 g. The pellet was discarded and the supernatant was centrifuged for 30 minutes at 90,000 g. After centrifugation, the pellet was resuspended with 20 ml of buffer 2 (60 mmol 1-1 mannitol, 7 mmol 1-1 EGTA, in a Tris base pH 7.4) with ten strokes of a Potter S homogenizer. The homogenate was supplemented with 200 μl 1 mol MgCl2 1-1 and incubated on ice for 30 minutes followed by centrifugation at 3000 g for 15 minutes. The pellet was discarded and the supernatant centrifuged at 90,000 g for 30 minutes. The resultant pellet was resuspended in a modified Tyrode's medium (2 mmol CaCl2 1-1, 3.1 mmol KCl 1-1 0.4 mmol MgCl26H2O 1-1, 100 mmol NaCl 1-1 , 25 mmol NaHCO3 1-1, 0.3 mmol NaH2PO42H2O 1-1, 10 mmol HEPES 1-1, 21.6 mmol Sodium lactate 1-1, 1 mmol sodium pyruvate 1-1) with ten strokes of a Potter S homogenizer. The suspension was centrifuged again for 30 minutes at 90,000 g and the supernatant discarded. The pellet was resuspended in 900 μl of the modified Tyrode's medium by aspiration through a 0.9×90 mm Yale spinal needle (Becton Dickinson, Oxford, UK). The APM, in aliquots of 500 μl, was snap-frozen in liquid nitrogen and stored at −80° C. until required. To extract a soluble APM protein fraction the APM was added to an equal volume of 2 mol NaCl 1-1 solution containing 2 μmol PMSF 1-1. The mixture was incubated at 40° C. for 30 minutes followed by centrifugation for 1 hour at 100,000 g at 10° C. The supernatant was carefully separated from the pellet and concentrated using Microcon 3,000 Dalton cut-off centrifugal filter devices (Millipore UK Ltd, Watford, UK). The concentrated soluble APM (sAPM) protein fraction was washed twice with a modified Tyrode's medium and stored at −80° C. Protein concentration was measured using the Bradford (Bradford, 1976) method, kit supplied by BioRad, Hemel Hempstead, UK.

Biotinylation of sAPM Proteins

Biotinylation of sAPM proteins was performed using EZ-Link Sulfo-NHS-LC-Biotin (Pierce, Rockford, Ill.). Biotin (30 μg) was incubated with the sAPM (200 μg protein in 100 μl PBS) for 30 minutes at room temperature. After incubation excess biotin was removed by a series of concentrating and washing steps using microfuge concentrators to a cut-off of 3,000 Daltons. The initial mixture was microcentrifuged for 75 minutes at 13,000 rpm. The retentate was collected by turning the concentrator upside down into a new vial and spinning for 4 minutes at 3,000 rpm. The retentate was re-suspended in PBS up to 100 μl and transferred to mini dialyzers (3,000 Dalton cut-off) (Pierce, Rockford Ill.). These were gently rotated in 400 ml PBS for 1 hour, repeated once more before leaving overnight in fresh PBS to remove excess biotin. The samples were transferred to microfuge concentrators (3,000 dalton cut-off) and spun for 90 minutes at 13,000 rpm. The retentate was collected by spinning for 4 minutes at 3,000 rpm and re-suspended in modified Tyrode's solution (as above) to approximately the original sAPM starting volume. The protein concentration of the samples was measured before freezing at −20° C. An aliquot of broad range protein standards (Biorad, Hemel Hempsted, Herts UK) was biotinylated, using the same method, to provide a visible reference for the molecular weights of experimental protein bands and confirmation of successful biotinylation.

Detection of sAPM Proteins Binding to Spermatozoa

To understand which molecules in sAPM bind to sperm membranes, biotinylated sAPM was coincubated with spermatozoa. Briefly, boar semen was prepared as previously described for co-incubation with APM (Fazeli et al, 2002). Two aliquots (40 ml each) of boar semen (mixed samples) from JSR Healthbred Limited (Thorpe Willoughby, Yorkshire, UK), diluted and stored for 24 hrs in Beltsville thawing solution Meister et al, 1976, were washed three times with PBS by centrifugation and re-suspension (600 g for 10 min). After the last centrifugation the supernatants were discarded, and the pellets re-suspended in modified Tyrode's medium supplemented with 12 mg ml 1-1 BSA. The washed semen samples, in aliquots of 1 ml, were overlaid with 500 μl of BSA-supplemented Tyrode's medium in 15 ml test tubes. The tubes were placed at a 45° angle in an incubator held at 39° C. in a humidified atmosphere saturated with 5% CO2. After one hour the top 0.5 ml of medium containing the swim-up sperm fraction from each tube was collected. Sperm motility and viability were examined. Sperm concentration was measured using a counting chamber. Sperm viability was assessed using a combination of Ethidium homodimer-1 (ETHD-1 Molecular Probes, Leiden, The Netherlands) and SYBR-14 (Molecular Probes). One microlitre of 2 mmol ETHD-11-1 and 2.5 μl of 20 μmol SYBR-14 1-1 were diluted in 1 ml of PBS. An equal volume of the dye mixture was added to the semen sample and incubated for 20 minutes at 39° C. An aliquot of this preparation was placed on a slide and evaluated by fluorescence microscopy. Viable spermatozoa with an intact plasma membrane excluding ETHD-1 demonstrated green fluorescence over the nucleus due to SYBR-14 staining. Spermatozoa with disrupted membranes showed red nuclear fluorescence due to ETHD-1 staining (Garner and Johnson, 1995). Two hundred spermatozoa were evaluated by fluorescence microscopy and classified as membrane intact (green) or membrane damaged (red).

Sperm concentration was adjusted to 50×106 ml-1 with TALP and biotinylated sAPM protein concentration adjusted to 300 μg ml 1-1 with Tyrode's solution with lactate and pyruvate (TLP). The biotinylated sAPM was added to an equal volume of spermatozoa and the suspension divided equally into two Eppendorf tubes and incubated at 39° C. and 5% CO2 in air for one hour.

After incubation the sperm suspensions were washed by microcentrifugation at 5,000 rpm for 4 minutes for removal of unbound sAPM. The supernatants containing unbound biotinylated sAPM were removed and stored for protein separation. The pellet containing sperm-bound biotinylated sAPM was re-suspended in 500 μl of PBS. The suspensions were centrifuged at 5,000 rpm for 4 minutes and the supernatants discarded. The pellets were resuspended in PBS and washed again. In order to prepare a crude suspension of biotinylated proteins bound to sperm membranes the pellets were resuspended in 10 μl of SDS sample buffer (50 mmol Tris 1-1 pH 6.8 and 0.5% SDS w/v) and mixed together. A further 20 μl of sample buffer was added to the suspension, which was incubated at room temperature for 90 minutes. The mixture was centrifuged at 13,000 rpm for 10 minutes. The soluble fraction comprising sperm surface proteins and bound biotinylated sAPM proteins was carefully aspirated with a pasteur pipette and stored at −80° C. The pellet (sperm solids) was re-suspended in 40 μl of sample buffer and stored. All samples were assayed for protein concentration.

Gel Electrophoresis

The discontinuous buffer system (Laemmli, 1970) polyacrylamide gel electrophoresis (PAGE) with sodium dodecyl sulphate (SDS) was used for the separation of protein samples. Five micrograms of protein, in volumes of 10 μl, was loaded in each lane of gels (12% separation, 5% stacking) under non-reducing conditions. Protein samples included biotinylated sAPM bound to sperm membranes, unbound biotinylated sAPM obtained after biotinylated sAPM binding to sperm, spermatozoa, non biotinylated sAPs and biotinylated broad range molecular weight standards. Gels were electrophoresed for approximately 45 minutes at 190 volts. Following electrophoresis the gels were equilibrated in transfer buffer (24 mmol Tris base 1-1, 192 mmol glycine 1-1, 20% methanol v/v pH 8.3) prior to transfer of the proteins from the gels on to nitrocellulose membranes by Western blotting (Towbin et al., 1979). Transfer was carried out at 100 mA for approximately 70 minutes. Gel electrophoresis and transfer procedures were carried out using the Protean 3 Modular Mini Electrophoresis System (Bio-Rad Labs, Hemel Hempstead, Herts, UK).

Detection and Visualisation of Biotinylated Proteins

Biotinylated protein bands, transferred to the nitrocellulose membranes, were detected through the tight binding affinity for biotin by NeutrAvidin, conjugated to horse-radish peroxidase KHRP), (SuperSignal West Dura Western Blotting Kit, Pierce, Rockford Ill.) following the instructions supplied. The procedure involved a series of washing steps incorporating incubation with NeutrAvidin/HRP and the application of the substrate peroxide, the signal of which was enhanced by luminol.

The membranes were wrapped carefully in cling film and any bubbles smoothed out prior to exposure to autoradiographic film for less than a minute. The films were developed to reveal the biotinylated protein bands.

Glycosylation status of sAPM proteins binding to sperinatozoa SDS-PAGE of sAPM proteins was performed as described earlier. Experimental lanes included samples from two separate preparations of sAPM and a set of commercially prepared standards containing glycosylated and non-glycosylated proteins (Candy Cane) (Molecular Probes, Leiden, NL). Proteins were electrophoresed at 190 volts for 46 minutes. After electrophoresis one of the two gels was fixed and stained with Brilliant Blue G-Colloidal Concentrate (Sigma). The remaining gel was fixed in 50% methanol v/v for 45 minutes and then washed twice in 3% acetic acid v/v for 10 minutes each. It was then incubated in oxidizing solution for 30 minutes on a rocking plate at 50 rpm. The gel was then washed three times in wash buffer for 5 minutes each. Pro-Q Emerald 300 (Molecular Probes) glycoprotein stain was added to the gel and incubated for 95 minutes in the dark with gentle agitation. The glycoprotein stain reacts with periodate-oxidized carbohydrate groups to create a bright green fluorescent signal. The gel was washed twice with wash buffer and then scanned Hewlett Packard Scanjet 6200c scanner) (Calif., USA) to produce a digital image of fluorescing protein bands.

Identification of sAPM proteins that bind to spermatozoa

Biotinylated and non-biotinylated sAPM proteins were separated by SDS-PAGE on two gels and transferred to PVDF membranes. The method for the detection of biotinylated proteins on the membranes was followed as previously described with the exception that one membrane was exposed only to the treatment buffers in order to prevent interference from factors that would impede sequencing. The remaining membrane was autoradiographed to visualise biotinylated sAPM proteins that had bound to spermatozoa and was used as a reference to excise protein bands from the non-autoradiographed membrane. Two protein bands at approximately 18 and 19 kDa were excised from two adjacent profiles. These were submitted for N-terminal sequencing using the Edman Degradation technique (Babraham Institute, Cambridge, UK).

Results

Biotinylation of sAPM proteins and detection of sAPM proteins binding to spermatozoa.

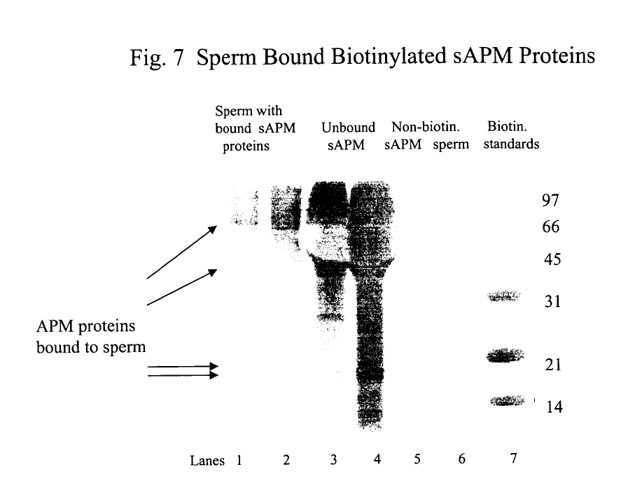

Protein profiles of sAPM, biotinylated and non-biotinylated, were identical as visualised by Brilliant Blue Colloidal G stain. The protein profile of the broad range molecular weight standard sample that was biotinylated in the same way as the sAPM also showed no difference from the profile of the non-biotinylated sample. Following incubation with Neutravidin and chemiluminescence all protein bands of the protein standards that had been biotinylated were clearly visible (FIG. 7, lane 7). This confirmed that the technique followed for biotinylating the protein samples was successful. No labelling was seen in the lanes where samples of non-biotinylated spermatozoa (FIG. 7, lane 5) and non-biotinylated sAPM (FIG. 7, lane 6) were run. However after sperm incubation with biotinylated sAPM, biotinylated proteins were detected (FIG. 7, lanes 1 and 2). These included two strongly labelled protein bands at approximately 18 and 19 kDa. Other bands were visible at approximately 37 and 70 kDa. Labelling was present only in lanes where biotinylated proteins were included, confirming the specificity of NeutrAvidin for biotin.

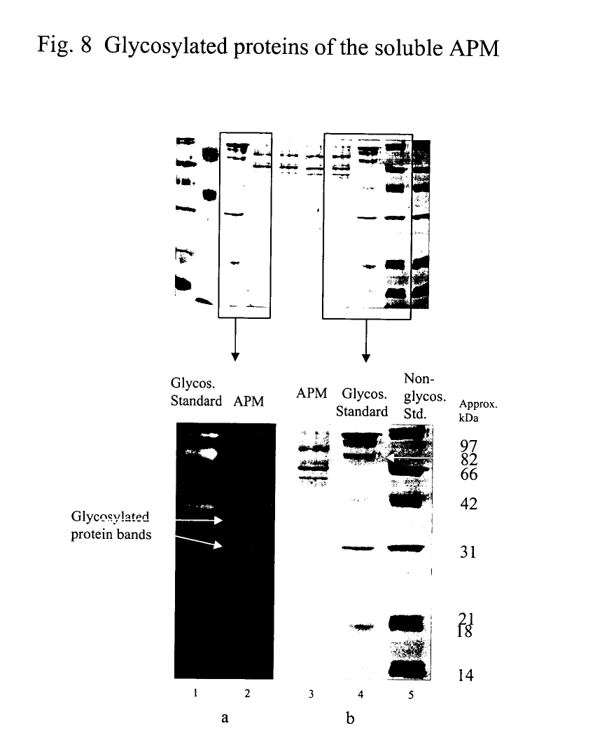

Glycosylation status of sAPM proteins using Pro-Q Emerald 300 glycoprotein stain. Positively glycosylated proteins in the Candy Cane molecular weight standards, where alternate protein bands were negatively and positively stained, were successfully identified (FIG. 8a, lane 4). Two bands of sAPM at approximate molecular weights of 31 kDa and 38 kDa and some bands with molecular weights above 80 kDa were detected to be glycosylated using this methodology (FIG. 8a, lane 2).

Identity of sAPM Proteins that Bind to Spermatozoa.

The N-terminal sequence derived from the protein band at approximately 18 kDa was MRYVASYLLA (Met Arg Tyr Val Ala Ser Tyr Leu Leu Ala) and exactly matched that of a known protein, acidic ribosomal protein P2. The protein at 19 kDa did not give a discernible sequence.

Discussion

In this example, several biotinylated protein components of porcine sAPM were detected within the solubilized sperm membrane protein profile; this indicates that they became bound. Two proteins, the molecular weights of which were approximately 18 and 19 kDa, were particularly prominent. Based on N-terminal sequencing of 10 amino acids, the protein band at 18 kDa was 100% homologous with a sequence found in acidic ribosomal protein (P2) (PIR database). The protein band at 19 kDa did not give a coherent sequence, and may therefore have consisted of more than one protein. Ribosomal protein (P2) does not interact directly with ribosomal RNA but binds to particles via P0 protein, and comprises the stalk protuberance, a distinct feature of the large subunit (Wahl and Moller, 2002). At first sight, it seems unlikely that binding would occur in vivo between spermatozoa and a ribosomal protein, and there are two possible explanations to consider. Either the authenticity of P2 identification is questionable, or the sAPM fraction has been heavily contaminated with cytoplasmic components. While the explanation is still unclear, there may be some reason to suppose that the protein in question is not acidic ribosomal protein P2. The molecular weight of acidic ribosomal protein P2 is reported as being in the region of 14 kDa (Lin et al., 1982; Vard et al., 1997) and is therefore around 20% smaller than the sperm-bound sAPM protein. The sperm-bound protein may therefore share the N-terminal sequence with P2, while belonging to a separate group of proteins that are yet to be discovered. Heavy contamination by cytoplasmic proteins is considered unlikely because (1) the APM is prepared by a membrane-selective technique and (2) a contaminant is likely to constitute only a minor proportion of the whole protein isolate rather than being among the most abundant components. In this study the enzyme γ-glutamyl transpeptidase was used to monitor the degree of APM membrane purification being achieved. This enzyme has been shown to reside mainly in the APM of polarized epithelial cells (Meister et al., 1976), and the assay has consistently shown that the method for isolating porcine APM from OEC is valid (Fazeli et al., 2003). The identity of the protein therefore remains unclear and raises the possibility that it might represent a new isoform. Further studies will be required to elucidate the issue.

Recently Reyes-Moreno et al., (2002) used the biotin-labelling method to examine bovine spermatozoa for the uptake of epididymal epithelial fluid proteins. The method successfully identified five specific proteins bound to the sperm surface. Working with the same species, Rodriguez and Killian, (1998) also used biotin labelling to examine bull sperm membranes following incubation with oviductal fluid proteins. They detected eight oviductal fluid proteins, ranging between 24 and 97 kDa that had bound to spermatozoa.

Carbohydrate moieties mediate sperm binding to the oviductal epithelium in the bull (Suarez et al., 1998) pig (Green et al., 2001), horse (Dobrinski et al., 1996), and mouse (DeMott et al., 1995) and may play a role in sperm viability enhancement (Tienthai et al., 2000). In this example we therefore looked for the presence of glycosylated proteins in porcine sAPM.

Glycosylation, a major form of protein and lipid modification, involves the attachment of carbohydrate moities to amino acid residues whereby N-linked glycoproteins attach to asparagine and O-linked glycoproteins link to serine or threonine. Two glycosylated protein bands were present within the sAPM protein profile with molecular weights less than 50 kDa. They did not match the two prominent bands identified by biotinylation as having bound to spermatozoa following co-incubation. However, the band identified at approximately 38 kDa could be homologous with that labelled by biotin at approximately 37 kDa.

Limitations of the techniques used within this study prevented further elucidation of the relationship between the two bands. The purpose of glycosylation is largely unknown. However some knowledge of function has been established that includes cell-cell interactions and cell routing by selectins (Gabius, 1997) and the regulation of transport and maturation of spermatozoa by protein-carbohydrate interactions. A family of major oviduct-specific oestrogen-dependent glycoproteins (OGP) with different molecular masses and carbohydrate contents are synthesized and released exclusively by the oviduct secretory epithelium in most mammals (Buhi, 2002). These have much higher molecular weights than the proteins we have identified as binding to boar spermatozoa during co-incubation. Although OGP's bind to spermatozoa as well as oocytes and embryos the apparent targets are the zonae pellucidae, the perivitelline space and membranes of oocytes or blastomeres (Buhi, 2002). Bovine spermatozoa treated with enriched or semi-purified OGP demonstrated increased motility and viability when added in a dose-dependent manner (Abe et al., 1995a). Boar spermatozoa also showed increased viability at lower concentrations of semi-purified OGP (reviewed in Buhi, 2002).

The function of the oviduct is not simply a passageway to the oocyte but a conditioning vessel to prepare spermatozoa for fertilization. Initially a viscous glycoprotein secretion in the caudal isthmus is involved in the removal of seminal plasma from the surface of boar spermatozoa following insemination (Hunter et al., 1998). Further oviductal secretions are involved in the release of bull spermatozoa from the oviduct (Talevi and Gualtieri, 2001). In between those events the oviductal APM supports spermatozoa until the optimal time for fertilization. The evidence presented here strongly supports the hypothesis that proteins, anchored to the OEC, bind populations of spermatozoa directly and that one, or more, of these proteins contributes to the enhancement of sperm viability.

The invention has been described and illustrated by means of a number of different specific examples. It will be appreciated, however, that the invention is not limited to the disclosure of these examples.

Proteins are known to associate with biological membranes in different ways. Some proteins do not extend into the hydrophobic interior of the lipid bilayer at all, but are bound to one or the other face of biomembranes by noncovalent interactions with other membrane proteins. Many of these can be released from the membrane by relatively gentle extraction procedures, such as exposure to solutions of very high or low ionic strength or extreme pH, which interfere with protein-protein interactions but leave the lipid bilayer intact; these proteins are referred to operationally as peripheral membrane proteins. By contrast, transmembrane proteins, proteins held in the bilayer by lipid groups, and some other tightly bound proteins cannot be released in these ways and therefore are called integral membrane proteins. In the current investigation, treating the membranes with a high ionic strength salt solution resulted in a solubilized peripheral membrane protein fractions of oviductal APM. As expected there were distinct differences between the visible protein profile of this soluble protein fraction compared to the original APM or the membrane protein fractions (pellet) left after the recovery of the peripheral membrane proteins (FIG. 2). The present inventors have identified that biological activity is still present in the peripheral membrane fraction. Therefore, the inventors have shown that active protein(s) responsible for the maintenance of sperm viability by oviductal APM belongs to the peripheral membrane protein category. This finding has physiological significance, and important technical implications regarding future strategies for purification and characterisation of active protein(s) responsible for maintaining boar sperm viability by oviductal APM preparations.

Preparation of the APM fractions involved extensive washing steps. These washing steps did not remove the biological activity. Thus, the inventors have shown that the membrane components responsible for the bioactivity are not readily soluble.

The proteins obtained by preparation of the APM fractions are unlike soluble proteins which are derived from the oviduct. These oviduct proteins are secreted into the oviduct and, if any were present at the start of the preparation of APM to obtain the present invention, these would certainly have been washed away by the washing steps.

The present invention further identifies the nature of the bioactive membrane components; these have been identified as one or more proteins having molecular weights of between approximately 10 and 100 kDa. In particular, proteins having molecular weights of approximately 95 kDa, approximately 60 to 70 kDa, approximately 41 kDa, approximately 38 kDa, approximately 19 kDa, approximately 18 kDa and approximately 13.5 kDa have been identified. The present inventors have further identified that a bioactive component of the present invention is ribonucleotideprotein-2.

In conclusion, the present invention has demonstrated the ability of proteins obtainable from oviductal APM to support and prolong sperm viability.

The use of AI has expanded considerably in the UK over the last 10 years, from around 14% in the early 1990's to about 50-60% of breeding at the present time.

Semen can be stored in dilute suspension in commercial diluents for about 3-5 days at ambient temperature. AI centres specialise in the collection of semen; they send it in diluted form by guaranteed next-day mail delivery to farmers, who then perform the AI on-farm using equipment also supplied by the AI centres. The semen can be kept alive on farms for 3-5 days, provided the temperature at which it is stored does not fall below 15° C.

Semen is known to be difficult to freeze; the viability of sperm is greatly reduced following cryopreservation. The present invention provides means for sperm viability to be higher following cryopreservation, thus enabling efficient freezing and subsequent provision of high numbers of viable sperm following freezing.

The present invention provides an effective diluent additive which enables AI centre operators to extend the shelf-life of the diluted semen beyond the 3-5 days currently guaranteed. Further, the present invention enables increased dilution of the semen without loss of fertility.

The present invention thus enables AI centres to reduce the size of their boar herds, thus reducing the output of waste, a goal that has recently been given high priority by the UK government and the EU.

1. A method of improving and/or prolonging sperm viability which comprises contacting spermatozoa with an isolated, cell-free, protein obtainable from a peripheral membrane fraction of oviductal apical plasma membrane (APM), or a fragment or derivative therefrom, the protein having a molecular weight of between approximately 10 kDa and 100 kDa.

2. A method according to claim 1 in which the spermatozoa are contacted with the protein in vitro.

3. A method according to claim 1 in which the spermatozoa are boar spermatozoa and the peripheral membrane fraction is of porcine oviductal APM.

4. A method of improving and/or prolonging sperm viability which comprises contacting spermatozoa with an isolated, cell-free protein obtainable from a peripheral membrane fraction of oviductal APM, or a fragment or derivative therefrom, the protein having a molecular weight of approximately 95 kDa.

5. A method of improving and/or prolonging sperm viability which comprises contacting spermatozoa with an isolated, cell-free protein obtainable from a peripheral membrane fraction of oviductal APM, or a fragment or derivative therefrom, the protein having a molecular weight of from approximately 60 to approximately 70 kDa.

6. A method of improving and/or prolonging sperm viability which comprises contacting spermatozoa with an isolated, cell-free protein obtainable from a peripheral membrane fraction of oviductal APM, or a fragment or derivative therefrom, the protein having a molecular weight of approximately 70 kDa.

7. A method of improving and/or prolonging sperm viability which comprises contacting spermatozoa with an isolated, cell-free protein obtainable from a peripheral membrane fraction of oviductal APM, or a fragment or derivative therefrom, the protein having a molecular weight of approximately 41 kDa.

8. A method of improving and/or prolonging sperm viability which comprises contacting spermatozoa with an isolated, cell-free protein obtainable from a peripheral membrane fraction of oviductal APM, or a fragment or derivative therefrom, the protein having a molecular weight of approximately 38 kDa.

9. A method of improving and/or prolonging sperm viability which comprises contacting spermatozoa with an isolated, cell-free protein obtainable from a peripheral membrane fraction of oviductal APM, or a fragment or derivative therefrom, the protein having a molecular weight of approximately 37 kDa.

10. A method of improving and/or prolonging sperm viability which comprises contacting spermatozoa with an isolated, cell-free protein obtainable from a peripheral membrane fraction of oviductal APM, or a fragment or derivative therefrom, the protein having a molecular weight of from approximately 19 to approximately 21 kDa.

11. A method of improving and/or prolonging sperm viability which comprises contacting spermatozoa with an isolated, cell-free protein obtainable from a peripheral membrane fraction of oviductal APM, or a fragment or derivative therefrom, the protein having a molecular weight of approximately 19 kDa.

12. A method of improving and/or prolonging sperm viability which comprises contacting spermatozoa with an isolated, cell-free protein obtainable from a peripheral membrane fraction of oviductal APM, or a fragment or derivative therefrom, the protein having a molecular weight of approximately 18 kDa.

13. A method of improving and/or prolonging sperm viability which comprises contacting spermatozoa with an isolated, cell-free protein obtainable from a peripheral membrane fraction of oviductal APM, or a fragment or derivative therefrom, the protein having a molecular weight of approximately 13.5 kDa.

14. A method of improving and/or prolonging sperm viability which comprises contacting spermatozoa with an isolated, cell-free protein obtainable from a peripheral membrane fraction of oviductal APM, or a fragment or derivative therefrom, in which the isolated protein comprises ribonucleotideprotein-2.

15. A method of improving and/or prolonging sperm viability which comprises contacting spermatozoa with ribonucleotideprotein-2 or a fragment or derivative therefrom.

16. A method of improving and/or prolonging sperm viability which comprises contacting spermatozoa with a protein other than ribonucleotideprotein-2 (acidic ribosomal protein P2), which protein includes all or part of the N-terminal sequence derived from acidic ribosomal protein P2.

17. A method according to claim 16 wherein said protein includes all or part of the sequence MRYVASYLLA or an analog or homolog thereof.

18. A method of improving and/or prolonging sperm viability following cryopreservation which comprises contacting spermatozoa with an isolated, cell-free protein obtainable from a peripheral membrane protein fraction of oviductal APM, or a fragment or derivative therefrom, the protein having a molecular weight of between approximately 10 kDa and 100 kDa.

19. A method of improving and/or prolonging sperm viability during cryopreservation which comprises contacting spermatozoa with an isolated, cell-free protein obtainable from a peripheral membrane protein fraction of oviductal APM, or a fragment or derivative therefrom, the isolated protein having a molecular weight of between approximately 10 kDa and 100 kDa.

20. A method of isolating a protein having a molecular weight of between approximately 10 kDa and 100 kDa, or a fragment or derivative therefrom, having sperm viability improving and/or prolonging activity from oviductal APM comprising the steps of:
(i) harvesting mammalian oviduct epithelial cells;
(ii) separation and isolation of a plasma membrane preparation using a magnesium chloride solution, and centrifugation to obtain a crude APM fraction;
(iii) extraction of a soluble fraction from the crude APM fraction using a salt solution and centrifugation of the solution obtained;
(iv) concentration of the supernatant and washing, to obtain protein.

21. A method according to claim 16 in which the salt solution used in step (iii) is sodium chloride solution.

22. An isolated, cell-free protein having a molecular weight of between approximately 10 kDa and 100 kDa or a fragment or derivative therefrom, having sperm viability improving and/or prolonging activity, the protein, fragment or derivative obtainable according to the following method:
(i) harvesting mammalian oviduct epithelial cells;
(ii) separation and isolation of a plasma membrane preparation using a magnesium chloride solution, and centrifugation to obtain a crude APM fraction;
(iii) extraction of a soluble fraction from the crude APM fraction using a salt solution and centrifugation of the solution obtained;
(iv) concentration of the supernatant and washing, to obtain protein.

23. A method according to claim 22 in which the salt solution used in step (iii) is sodium chloride solution.

24. A method of improving and/or prolonging sperm viability which comprises contacting spermatozoa with an isolated, cell-free protein obtainable from a peripheral membrane fraction of oviductal APM, or a fragment or derivative therefrom, the protein having a molecular weight of between approximately 10 kDa and 100 kDa, in which the spermatozoa are microencapsulated.

25. A method according to claim 21 in which the treated spermatozoa are microencapsulated in a semi-permeable membrane comprising poly-lysine.

26. A method of improving and/or prolonging sperm viability comprising contacting spermatozoa with an isolated, free protein obtainable from a peripheral membrane fraction of oviductal APM, or a fragment or derivative therefrom, the protein having a molecular weight of between approximately 10 kDa and 100 kDa, in which the proteins are linked to inert polymers.

27. A method according to claim 26 in which hydrophilic polymers are used.

28. A method according to claim 26 in which the polymer is amine- and carbonyl-reactive dextran.

29. A method for improving and/or prolonging sperm viability which comprises contacting spermatozoa with an isolated, cell-free protein obtainable from a peripheral membrane fraction of oviductal APM, or a fragment or derivative therefrom, the protein having a molecular weight of between approximately 10 kDa and 100 kDa, in which the protein is present in a concentration of between approximately 1 μg/L and approximately 1 g/L.

30. A method according to claim 29 in which the protein is present in a concentration of between approximately 5 μg/L and approximately 400 g/L.

31. A method according to claim 29 in which the protein is present in a concentration of between approximately 25 μg/L and approximately 200 μg/L.

32. A method of improving and/or prolonging semen survival following sex-sorting of the spermatozoa for X- (female) and Y-bearing (male) spermatozoa cells which comprises contacting spermatozoa with an isolated protein obtainable from a peripheral membrane fraction of oviductal APM, or a fragment or derivative therefrom, the protein having a molecular weight of between approximately 10 kDa and 100 kDa.

33. A sperm diluent which includes an additive comprising an isolated, cell-free protein obtainable from a peripheral membrane fraction of oviductal APM, or a fragment or derivative therefrom, the protein having a molecular weight of between approximately 10 kDa and 100 kDa, in which the protein, fragment or derivative has sperm viability improving and/or prolonging activity.

34. A sperm diluent according to claim 33 in which the sperm diluent or additive is synthetic.

35. An isolated, cell-free protein obtainable from a peripheral membrane fraction of oviductal APM, the protein having a molecular weight of between approximately 10 kDa and 100 kDa, or a fragment or derivative therefrom, in which the protein, fragment or derivative has sperm viability improving and/or prolonging activity.

36. An isolated, cell-free protein obtainable from a peripheral membrane fraction of oviductal APM, or a fragment or derivative therefrom, the protein having a molecular weight of approximately 95 kDa, in which the protein, fragment or derivative has sperm viability improving and/or prolonging activity.

37. An isolated, cell-free protein obtainable from a peripheral membrane fraction of oviductal APM, or a fragment or derivative therefrom, the protein having a molecular weight of from approximately 60 to approximately 70 kDa, in which the protein, fragment or derivative has sperm viability improving and/or prolonging activity.

38. An isolated, cell-free protein obtainable from a peripheral membrane fraction of oviductal APM, or a fragment or derivative therefrom, the protein having a molecular weight of approximately 70 kDa, in which the protein, fragment or derivative has sperm viability improving and/or prolonging activity.

39. An isolated, cell-free protein obtainable from a peripheral membrane fraction of oviductal APM, or a fragment or derivative therefrom, the protein having a molecular weight of approximately 41 kDa, in which the protein, fragment or derivative has sperm viability improving and/or prolonging activity.

40. An isolated, cell-free protein obtainable from a peripheral membrane fraction of oviductal APM, or a fragment or derivative therefrom, the protein having a molecular weight of approximately 38 kDa, in which the protein, fragment or derivative has sperm viability improving and/or prolonging activity.

41. An isolated, cell-free protein obtainable from a peripheral membrane fraction of oviductal APM, or a fragment or derivative therefrom, the protein having a molecular weight of approximately 37 kDa, in which the protein, fragment or derivative has sperm viability improving and/or prolonging activity.

42. An isolated, cell-free protein obtainable from a peripheral membrane fraction of oviductal APM, or a fragment or derivative therefrom, the protein having a molecular weight of from approximately 19 to approximately 21 kDa, in which the protein, fragment or derivative has sperm viability improving and/or prolonging activity.

43. An isolated, cell-free protein obtainable from a peripheral membrane fraction of oviductal APM, or a fragment or derivative therefrom, the protein having a molecular weight of approximately 19 kDa, in which the protein, fragment or derivative has viability improving and /or prolonging activity.

44. An isolated, cell-free protein obtainable from a peripheral membrane fraction of oviductal, or a fragment or derivative therefrom, the protein having a molecular weight of approximately 18 kDa, in which the protein, fragment or derivative has sperm viability improving and/or prolonging activity.

45. An isolated, cell-free protein obtainable from a peripheral membrane fraction of oviductal APM, or a fragment or derivative therefrom, the protein having a molecular weight of approximately 13.5 kDa, in which the protein, fragment or derivative has sperm viability improving and/or prolonging activity.

46. An isolated cell free protein, other than ribonucleotideprotein-2 (acidic ribosomal protein P2). which protein includes all or part of the N-terminal sequence derived free acidic ribosomal protein P2.

47. An isolated, cell free protein according to claim 46 which includes all or part of the sequence or an analog or homolog thereof.

48. Use of an isolated, cell-free protein obtainable from a peripheral membrane fraction of oviductal APM, or a fragment or derivative h e, the protein having a molecular weight of between approximately 10 kDa 100 kDa, in the manufacture of a composite for improving and/or prolonging sperm viability.

49. Use of ribonucleotide-2 or a fragment or derivative therefrom in the manufacture of a composition for improving and/or prolonging sperm viability.

50. Use of a protein other than ribonucleotideprotein-2 (acidic ribosomal protein P2), which protein includes all or part of the N-terminal sequence derived from acidic ribosomal protein P2, in the manufacture of a composition for improving and/or prolonging sperm viability.

51. Use of a protein which includes all or part of the sequence MRYVASYLLA or an analog or homolog thereof, in the manufacture of a composition for improving and/or prolonging sperm viability.

52. Use of an isolated, cell-free protein obtainable from a peripheral membrane fraction of oviductal APM, or a fragment or derivative therefrom, the protein having a molecular weight of between approximately 10 kDa and 100 kDa, in the manufacture of a composition for improving and/or prolonging sperm viability following cryopreservation.

53. Use of an isolated, cell-free protein obtainable from a peripheral membrane fraction of oviductal APM, or a fragment or derivative therefrom, the protein having a molecular weight of between approximately 10 kDa and 100 kDa, in the manufacture of a composition for improving and/or prolonging sperm viability during cryopreservation.

54. Spermatozoa together with an isolated, cell-free protein obtainable from a peripheral membrane fraction of oviductal APM, or a fragment or derivative therefrom, the protein having a molecular weight of between approximately 10 kDa and 100 kDa and having sperm viability improving and/or prolonging activity, which are microencapsulated with a semi-permeable membrane.

55. Spermatozoa together with an isolated, cell-free protein obtainable from a peripheral membrane fraction of oviductal APM, or a fragment or derivative therefrom, the protein comprising ribonucleotideprotein-2, or a protein other than ribonucleotideprotein-2 (acidic ribosomal protein P2), which protein includes all or part of the N-terminal sequence derived from acidic ribosomal protein P2, or a protein which includes all or part of the sequence MRYVASYLLA or an analog or homolog thereof, and having sperm viability improving and/or prolonging activity, which are microencapsulated with a semi-permeable membrane.

56. A method for identifying an isolated, cell-free protein obtainable from a peripheral membrane fraction of oviductal APM, or a fragment or derivative therefrom, the protein having a molecular weight of between approximately 10 kDa and 100 kDa and having sperm viability improving and/or prolonging activity the method comprising:
(i) labelling peripheral APM proteins with a marker
(ii) allowing the labelled APM proteins to bind to surface proteins of spermatozoa
(iii) washing to remove excess APM
(iv) adding a detergent to solubilise sperm surface proteins
(v) identifying the isolated proteins labelled with the marker which have bound to the surface proteins of the spermatozoa.

57. An isolated, cell-free protein obtainable from a peripheral membrane protein fraction of oviductal APM, or a fragment or derivative therefrom, the protein having a molecular weight of between approximately 10 kDa and 100 kDa and having sperm viability improving and/or prolonging activity, the protein obtained according to the following method:
(i) labelling peripheral APM proteins with a marker
(ii) allowing the labelled APM proteins to bind to surface proteins of spermatozoa
(iii) washing to remove excess APM
(iv) adding a detergent to solubilise the sperm surface proteins
(v) identifying the APM proteins labelled with the marker which have bound to the surface proteins of the spermatozoa
(vi) separating the labelled APM proteins from the surface proteins of the spermatozoa to obtain isolated protein.
